(19) United States
(12) Patent Application Publication
(10) Pub. No.: US 2010/0265167 A1
(43) Pub. Date: Oct. 21, 2010

(54) LIGHT EMITTING APPARATUS AND DISPLAY APPARATUS USING LIGHT EMITTING APPARATUS

(75) Inventor: Junichi KINOSHITA, Imabari-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: HARISON TOSHIBA LIGHTING Corp., Imabari-shi (JP)

(21) Appl. No.: 12/748,789

(22) Filed: Mar. 29, 2010

(30) Foreign Application Priority Data
Apr. 21, 2009 (JP) 2009-103227

(51) Int. Cl. G09G 3/32; F21V 1/00

(52) U.S. Cl. 345/82; 362/235

(57) ABSTRACT

A light emitting apparatus according to the present invention having an illuminant surface and configured to be able to adjust brightness for each of a plurality of divided areas of the illuminant surface, includes: an LD chip as a light source including a plurality of light emitting elements that can be independently driven, and configured to emit light from the plurality of light emitting elements; a plurality of fiber waveguide portions each coupled to at least one of the plurality of light emitting elements and configured to transmit light from the at least one of the plurality of light emitting elements coupled; and a plurality of minute wavelength conversion members each placed for each of the areas, configured to take in the light transmitted via corresponding fiber waveguide portions, and emit the taken-in light.

### CROSS-REFERENCE TO RELATED APPLICATIONS

This application is based upon and claims the benefit of priority from the prior Japanese Patent Application No. 2009-103227 filed in Japan on Apr. 21, 2009; the entire contents of which are incorporated herein by reference.

### BACKGROUND OF THE INVENTION

1. Field of the Invention

The present invention relates to a light emitting apparatus and a display apparatus using the light emitting apparatus, and more particularly to a light emitting apparatus configured to be able to adjust brightness and chromaticity for each of plural illuminant surface areas and a display apparatus using the light emitting apparatus.

2. Description of the Related Art

A surface illumination apparatus utilizing light output from a solid-state light emitting element such as a light emitting diode (LED) has been used as a backlight unit (BLU) for a liquid crystal display (LCD). Such LED backlight is replacing the conventional backlight units still using cold cathode fluorescent lamps (CCFL) containing mercury. The surface illumination apparatus using LEDs is advantageous as a backlight unit in energy saving due to higher efficiency, mercury-free eco-friendliness, longer life and its thin and lightweight structure.

The backlight unit, as a system for converting light from a plurality of light emitting elements (an LED array) into smooth and uniform surface light emission, uses a light guide plate. This is also known as a side-light system in which light from a linear LED array placed on a side or sides of a light guide plate is optically coupled into it. The other backlight system is a direct-view system of placing a diffusion plate above a plurality of LEDs arranged in a two-dimensional matrix array (for example, see Japanese Patent Application Laid-Open Publication No. 2005-316337).

For example, perspective views of a light guide plate type surface illumination apparatus, a direct-view type surface illumination apparatus using a 2-D LED array, and a direct-view type surface illumination apparatus using cold cathode fluorescent lamps are shown in FIG. 7, FIG. 8 and FIG. 9, respectively.

The light guide plate type surface illumination apparatus 100 shown in FIG. 7 includes an LED array 102 constituted by a plurality of LED packages 101 on each of two side portions and a stack of optical films 104 including a diffusion plate and a prism films, which are provided on the light guide plate 103. In FIG. 7, light output from the LED array 102 provided on each side is optically coupled into the light guide plate 103. Then the coupled light travels inside the light guide plate 103 repeating total-reflection, and spreads all over the surface of the light guide plate 103. On the surface of the light guide plate, fine patterns of output recess are optimally arranged for controlling luminance uniformity of surface-emission. The stack of optical films 104 is illuminated by light output from the patterns. The stack of optical films contributes to optical diffusion. It is easier for the side-light type backlight using the lightguide plate to make itself thin.

A direct-view type surface illumination apparatus 200 shown in FIG. 8 includes a two-dimensional LED array 105 constituted by a plurality of LED packages 101 arranged in a two-dimensional matrix array, and a stack of optical films 104 provided above the two-dimensional LED array 105. In FIG. 8, light from the two-dimensional LED array 105 mounted on a PCB is optically diffused via the stack of optical films 104 to obtain smooth and uniform surface light emission. The direct-view backlight need a certain thickness compared with the lightguide plate type because it is necessary to convert too many spot-like “MURA” of the light emission from the 2D LED array into uniform and smooth on the illuminant surface.

Another direct-view type surface illumination apparatus 300 shown in FIG. 9 includes a cold cathode fluorescent lamp array 107 constituted by a plurality of long cold cathode fluorescent lamps 106 arranged in parallel, and a stack of optical films 104 provided above the cold cathode fluorescent lamp array 107. In FIG. 9, light from the cold cathode fluorescent lamp array 107 provided on a bottom surface is optically diffused via the stack of optical films 104 to obtain smooth and uniform surface light emission.

Small-size, thin and low-cost LCDs usually use the light guide plate type surface illumination apparatus because of less number of LED usage. Large-size LCDs mostly use the direct-view type surface illumination apparatus.

The direct-view type surface illumination apparatus can easily be applied for a local dimming system, and is suitable for a backlight unit of an LCD-TV that values image quality and energy saving. The local dimming system can spatially modulate luminance on a surface of a backlight unit in harmony with an image signal of the LCD. Specifically, for darker areas in an image, corresponding areas on the surface of the backlight unit are also darkened. Meanwhile, for brighter areas, corresponding areas on the backlight unit is lightened.

A conventional backlight unit uses a simple full-lighting system. That is, the entire backlight surface is illuminated at constant brightness necessary for full-white LCD mode. Therefore, it is difficult to save power consumption even if the image is dark. On the other hand, in the local dimming system, the backlight surface areas corresponding to dark image areas can be darkened to reduce power consumption.

A liquid crystal panel itself has a poor contrast ratio performance. If the backlight unit is full-lit, the light transmits through the liquid crystal panel even with a black signal, causing impaired contrast of an image. On the other hand, in the local dimming system, backlight areas corresponding to a dark image part is darkened, and thus the contrast ratio of the image on the LCD is drastically improved.

FIG. 10 is a diagram illustrating such a local dimming system.

In FIG. 10, when a backlight unit is, for example, a backlight unit 1000 of a LCD for a TV set with a diagonal size of 52 inches, a surface of the backlight unit 1000 is divided into 16×32=512 areas 1001, 1002, . . . 1512.

Each of the divided areas is a local area, and four LEDs are mounted in each of the areas 1001, 1002, . . . 1512. Specifically, the total number of LEDs in the entire backlight unit 1000 is 4 pcs×512 areas=2048 pcs. The four LEDs for each area are controlled harmonized with an image to realize the local dimming system.

An advanced local dimming system can control output from each of red, green, blue LED dice mounted in one package (Three-in-one RGB-LED) harmonized with the RGB color signals. In that case, power consumption is further reduced and image quality is also improved.

A configuration of the LED in the color local dimming system is described as follows. As shown in FIG. 10, a three-in-one LED package 101 is used such that LED chips 101a, 101b and 101c of respective RGB colors are mounted in one LED package 101. Thus, for the RGB system, the number of LED chips used is 2048×3=6144.

As in the above, the direct-view type backlight unit requires a vast number of LEDs resulting in increasing the cost of mount and binning process of such a large number of LEDs.

At least one LED is required for one area, anyway. Therefore, it is necessary to use more LEDs for improving image quality by finer resolution of local dimming areas.

Considering an image display only with LEDs without a liquid crystal module, two million pixels or more are required for full high definition, and it is further difficult to realize an image display using such discrete semiconductor light emitting devices like LEDs except ultra-large outdoor LED display. However, if realized, it is superior to a liquid crystal display in power consumption and contrast as described above.

The direct-view type backlight unit requires a PCB for mounting LEDs under the entire illuminant surface. Therefore, PCB is heavier and larger for larger LCD size, increasing the cost of the apparatus itself.

The local dimming areas cannot be configured by the light guide plate system or the cold cathode fluorescent lamp system. Thus, it is difficult for lightguide plate or cold cathode fluorescent lamp to apply to the local dimming system. Thus, the local dimming system is currently realized by the direct-view type LED backlight as described above.

In summary, a direct-view type local dimming system is superior in power consumption and contrast, but it requires a vast number of LEDs mounted on a PCB, increasing entire costs and weight of the system. Plus, it is difficult to make the backlight itself thinner than the lightguide plate type backlight.

That is, it has been difficult to realize a direct-view type light emitting apparatus with less weight and lower costs.

### BRIEF SUMMARY OF THE INVENTION

An object of the present invention is to provide a light emitting apparatus configured to be able to perform a local dimming operation without using a conventional large PCB and a display apparatus using the light emitting apparatus.

One aspect of the present invention provides a light emitting apparatus having an illuminant surface and configured to be able to adjust brightness or chromaticity for each of plural divided areas on the illuminant surface, includes: an integrated light source which monolithically integrates a plurality of light emitting elements which can be independently driven; and a plurality of optical transmission lines configured to distribute a light output of each light emitting element of the integrated light source to each of the divided areas.

One aspect of the present invention provides a display apparatus configured to display an image based on input image signals, including a light emitting apparatus according to the above-described invention as a backlight unit, and wherein brightness or chromaticity is adjusted for each of areas according to the input image signals.

### BRIEF DESCRIPTION OF THE DRAWINGS

FIGS. 1A and 1B are diagrams for illustrating a light emitting apparatus according to a first embodiment of the present invention, FIG. 1A is a partially cutaway perspective view of the light emitting apparatus according to the first embodiment of the present invention, and FIG. 1B is a sectional view taken along the line A-A in FIG. 1A;

FIG. 2 is a perspective view for illustrating a configuration of an LD chip as a light source of the light emitting apparatus in FIG. 1;

FIG. 3 is a partially cutaway perspective view of the light emitting apparatus according to the first embodiment of the present invention;

FIG. 4 is a partially cutaway perspective view of a light emitting apparatus according to a second embodiment of the present invention;

FIG. 5 is a partially cutaway perspective view of a light emitting apparatus according to a third embodiment of the present invention;

FIG. 6 is a perspective view showing an LD chip of a light emitting apparatus according to a fourth embodiment of the present invention;

FIG. 7 is a perspective view showing an example of a conventional light guide plate type surface illumination apparatus;

FIG. 8 is a perspective view showing an example of a conventional direct-view type surface illumination apparatus;

FIG. 9 is a perspective view showing an example of a conventional direct-view type surface illumination apparatus using a cold cathode fluorescent lamp;

FIG. 10 is a diagram for illustrating a local dimming system;

FIGS. 11A and 11B are diagrams for illustrating a configuration and beam divergence of an LED chip as a conventional light source, FIG. 11A is a perspective view showing a configuration of the LED chip as the conventional light source, and FIG. 11B is a diagram showing angular distribution characteristics of light emission from the LED chip in FIG. 11A; and

FIG. 12 is a perspective view showing a configuration of an LD chip as a conventional light source.

### DETAILED DESCRIPTION OF THE INVENTION

Now, embodiments of the present invention will be described with reference to the drawings.

### First Embodiment

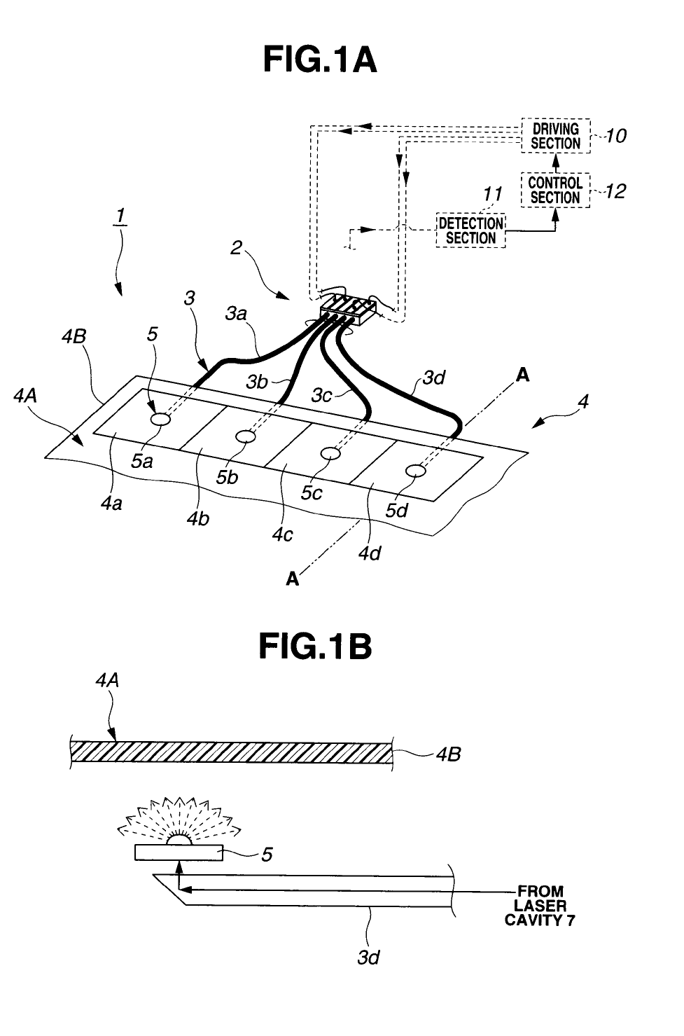

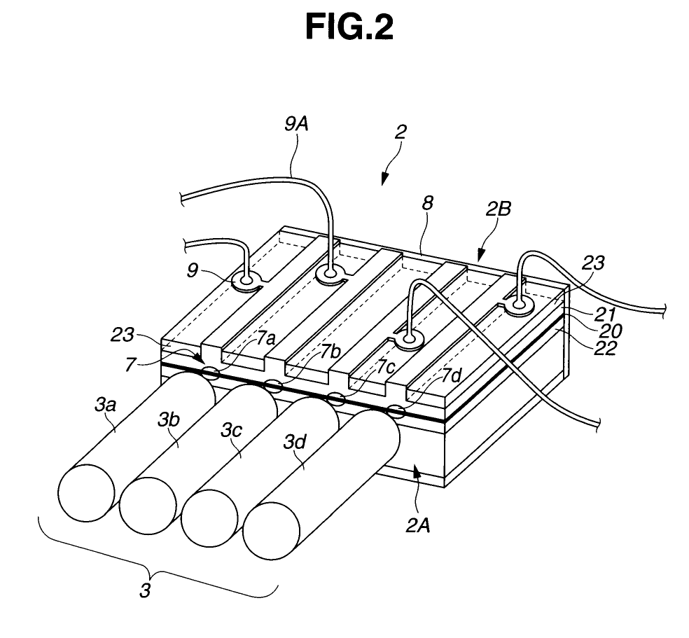

FIGS. 1A and 1B are diagrams for illustrating a light emitting apparatus according to a first embodiment of the present invention. FIG. 1A is a partially cutaway perspective view of the light emitting apparatus according to the first embodiment of the present invention. FIG. 1B is a sectional view taken along the line A-A in FIG. 1A. FIG. 2 is a perspective view for illustrating a configuration of a diode laser chip as a light source of the light emitting apparatus according to the first embodiment of the present invention. Diode laser or semiconductor laser is abbreviated expression as LD (Laser Diode).

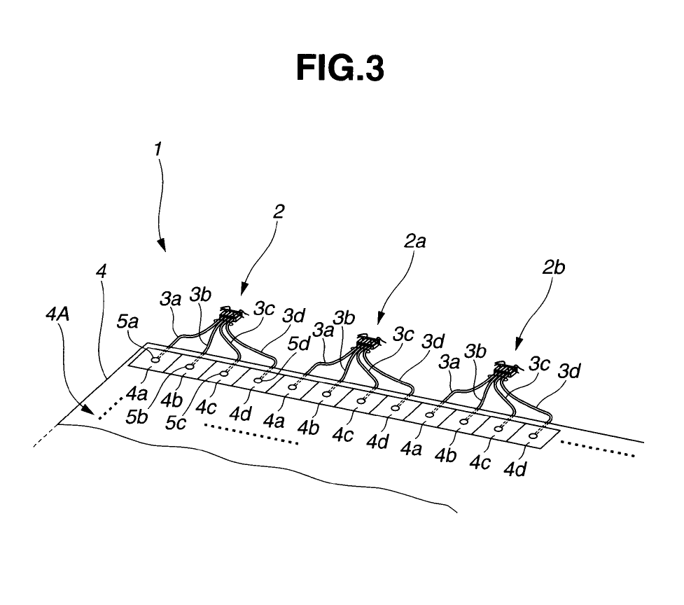

The light emitting apparatus 1 in FIG. 1A has a planar illuminant surface 4A. The illuminant surface 4A is divided into a plurality of areas, and in FIG. 1A, only four areas 4a, 4b, 4c and 4d are shown for simplicity. Thus, light emission of the four areas 4a to 4d will be described below. In FIG. 1A, only a plurality of (four in FIG. 1) areas laterally arranged in line are shown, but actually, as illustrated in FIG. 3, a number of areas are arranged across the entire illuminant surface 4A.

The light emitting apparatus 1 includes an LD chip 2 as a light source, a waveguide portion 3 as an optical transmission line, a backlight unit body 4, and a plurality of minute wavelength conversion members 5. The wavelength conversion member is, for example, a phosphor, and has a function of converting a light output from a laser element oscillating at a specific wavelength (for example, blue laser light) into a white light.

The light source 2 is placed in a position close to a side surface of the backlight unit body 4 of the light emitting apparatus 1, or a position spaced apart from the side surface of the backlight unit body 4.

The backlight unit body 4 of the light emitting apparatus 1 is a casing having a thin box-like outer shape. A stack of optical films including a diffusion film 4B or the like is provided to face the minute wavelength conversion member 5, and light is emitted in a diffused manner via the illuminant surface 4A on an upper surface of the diffusion film 4B to cause surface light emission.

The light source 2 is an integrated LD chip including a plurality of (herein four) semiconductor laser cavities, and emits laser light from each cavity. Specifically, the light source 2 is an integrated light source constituted by a plurality of integrated semiconductor laser cavities 7a to 7d that can be independently driven, and each laser cavity emits laser light having very narrow angle beam divergence.

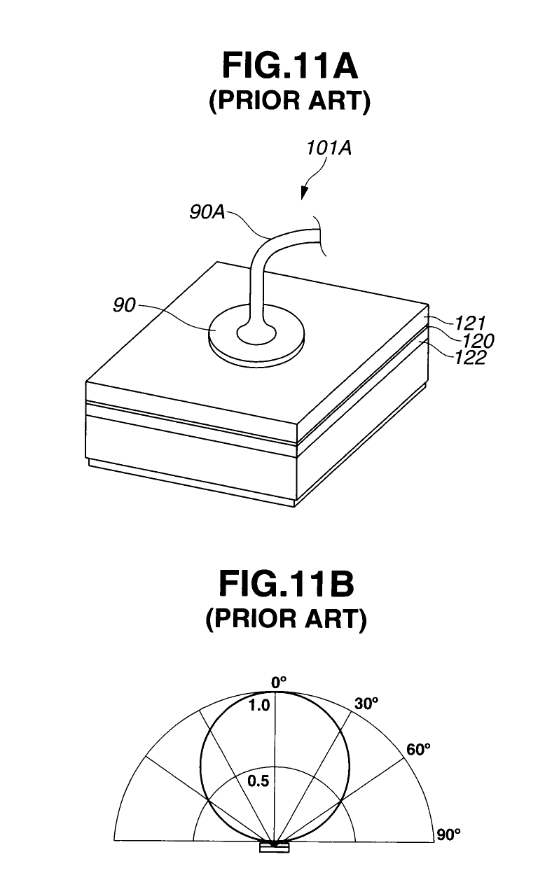

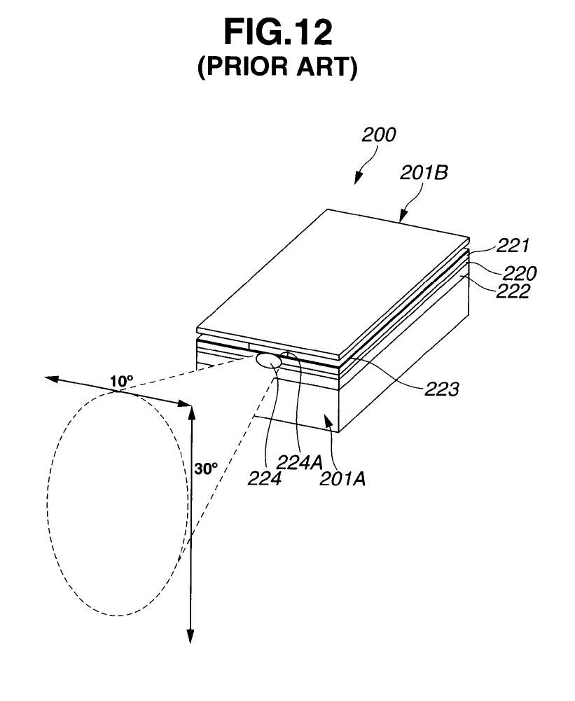

Differences in configurations and optical characteristics from a conventional LED chip and LD chip will be described with reference to FIGS. 11A, 11B and 12.

FIG. 11A is a perspective view showing a configuration of an LED chip as a conventional light source. FIG. 11B is a diagram showing angular distribution characteristics of light emission from the LED chip in FIG. 11A. FIG. 12 is a perspective view showing a configuration of an LD chip as a conventional light source.

An LED chip 101A in FIG. 11A is a surface emission type, and emits light from substantially the entire surface of the LED chip 101A. The LED chip 101A includes an active layer 120 that emits light, a p-type cladding layer 121 and an n-type cladding layer 122 stacked to vertically sandwich the active layer 120, a bonding pad 90, and a gold wire 90A. The LED chip 101A is electrically driven via the gold wire 90A.

The optical output from an LED chip 101A basically has a Lambertian distribution (Lambert's cosine law, perfectly diffusing surface) and a full width at half maximum is 120° as shown in FIG. 11B.

If such one LED chip 101A is divided into a plurality of areas that can be independently driven, separate electrodes for independent driving or a bonding pad for a gold wire is required. Further, it is difficult to couple the extremely wide Lambertian distribution to a waveguide (or lightguide body) for each area and transmit the output to a predetermined position in the backlight unit.

On the other hand, an LD chip 201 in FIG. 12 is an edge emission type, having a waveguide mesa stripe 224A with a width of several microns. Specifically, an optical cavity 224 is formed having a front cleaved facet 201A and a rear cleaved facet 201B as mirror reflective surfaces.

A layer structure of the LD chip 201 includes an active layer 220 that emits light, a p-type cladding layer 221 and an n-type cladding layer 222 stacked to vertically sandwich the active layer 220, and an insulating film 223.

For such an LD chip 201, electrical power is supplied only to the active layer 220 along the optical cavity 224. Because the insulating film 223 blocks a current, a current passes through only the active layer 220 along the optical cavity 224, producing gain for lasing only in this stripe region.

The LD chip 201 is configured to have a width of, for example, about 300 μm, and portions other than the optical cavity 224 do not actually contribute to light emission. For such an LD chip 201, a light output from the front facet 201A has beam divergence with full widths at half maximum (FWHM) of about 10° in a horizontal direction parallel to a surface of the active layer 220, and about 30° in a lateral direction perpendicular to the surface of the active layer 220. Thus, the LD chip 201 has extremely narrower beam divergence than the LED chip 101A shown in FIG. 11B.

The light emitting apparatus 1 according to the present embodiment uses such an LD chip having narrow angle beam divergence as the light source 2.

Next, a configuration of the LD chip used as the light source 2 of the light emitting apparatus 1 of the present embodiment will be described with reference to FIG. 2. The light source 2 as an LD chip 2 will be described.

As shown in FIG. 2, the LD chip 2 is configured as an InGaN (indium gallium nitride)-based LD chip that emits, for example, a violet light of 405 nm.

The LD chip 2 includes an active layer 20 that emits light, a p-type cladding layer 21 and an n-type cladding layer 22 stacked to vertically sandwich the active layer 20, and an insulating film 23. The LD chip 2 includes a plurality of laser cavities 7, a reflectivity film 8, a plurality of bonding pads 9, and a plurality of gold wires 9A substantially the same as those of the optical cavity 224 (see FIG. 12). As the plurality of laser cavities 7, only four laser cavities 7a, 7b, 7c and 7d are herein shown. Specifically, the case is shown where the LD chip 2 includes a total of four light emitting elements. The LD chip 2 is configured to have a width of, for example, 400 μm. The laser cavities 7a to 7d are configured at an interval of, for example, 100 μm.

The width of the LD chip 2 and the interval between the laser cavities 7a to 7d fall within a range that allows the bonding pads 9 and the gold wires 9A required for independently driving and modulating the laser cavities 7a to 7d to be provided. However, the width of the LD chip 2 and the interval between the laser cavities 7a to 7d are not limited thereto, and may be changed as required.

A high reflectivity (HR) film 8 is coated on a rear facet 2B of the LD chip 2. The HR film 8 is made of a multi-layered dielectric materials to emit most of lasing power efficiently from a front facet 2A.

On the front facet 2A of the LD chip 2, the four laser cavities 7a to 7d are placed as described above. Each near-end of the four laser cavities 7a to 7d, is optically coupled with each end of fiber waveguide portions 3a to 3d. The fiber waveguide portions 3a to 3d transmit light from the laser cavities 7a to 7d to minute wavelength conversion members 5a to 5d (see FIG. 1A) placed on areas 4a to 4b, respectively, of the backlight unit body 4 described below.

The backlight unit body 4 has the plurality of divided areas of the illuminant surface 4A as shown in FIG. 1A. As described above, only four areas 4a to 4d are shown in FIG. 1A. The minute wavelength conversion members 5a to 5d as optical members are provided on the four areas 4a to 4d, respectively.

In each of the four areas 4a to 4d, the far end of the fiber waveguide portions 3a to 3d is placed. More specifically, far ends of the fiber waveguide portions 3a to 3d are set at positions of the minute wavelength conversion members 5a to 5d on the areas 4a to 4d, as shown in FIG. 1B. With such a configuration, as shown by broken arrows in FIG. 1B, output light from the laser cavity 7 can be guided to the minute wavelength conversion members 5a to 5d on the areas 4a to 4d.

The minute wavelength conversion members 5a to 5d contain a phosphor for converting a violet light output having a wavelength of 405 nm from the far ends of the fiber waveguide portions 3a to 3d in the areas 4a to 4d into a white light having chromaticity/color temperature suitable for a backlight unit.

Thus with such a configuration, one InGaN-based LD chip 2 having the four laser cavities 7a to 7d can transmit light to the four areas 4a to 4d of the backlight unit body 4, and the areas 4a to 4d are independently driven and modulated to realize a local dimming operation.

The light emitting apparatus 1 may include, as shown in FIG. 1A, a driving section 10 configured to drive the LD chip 2, a detection section 11 configured to detect a small part of the light output of the laser cavity 7, and a control section 12 configured to control the driving section 10 based on the monitored result detected by the detection section 11 to adjust an applied current passing through the LD chip 2 and control a light output of the LD chip 2.

The laser cavities 7a to 7d as the light emitting elements are generally based on the waveguide portion shaped like a stripe as in the present embodiment, but may be configured perpendicularly to a chip surface like a VCSEL (Vertical Cavity Surface Emitting Laser). The light emitting element may be an edge emission type LED (EE-LED) in which a waveguide type cavity just amplifies light even if it does not yet reach laser threshold.

In the present embodiment, the term laser (Light Amplification by Stimulated Emission of Radiation) refers to light amplification by stimulated emission irrespective of the presence of laser oscillation above the threshold. Thus, the VCSEL driven at lower current than threshold is often referred to as an RC-LED (Resonant-Cavity LED), and it is also included in the laser cavity for the same reason.

Next, an operation of the light emitting apparatus 1 having such a configuration will be described. For the light emitting apparatus 1 shown in FIG. 1A, one LD chip 2 can transmit light to, for example, four areas 4a to 4d of the backlight unit body 4, and the areas can be independently driven and modulated to allow substantially the same local dimming operation as the local dimming system described with reference to FIG. 10.

Specifically, when a display apparatus is configured using the backlight unit body 4, a dark image portion in an image signal input to the display apparatus is darkened, thereby reducing power consumption and increasing contrast.

The light emitting apparatus 1 shown in FIG. 1A eliminates the need for a conventional PCB required for the direct-view type local dimming operation, and also one LD chip 2 includes a plurality of cavities, thereby reducing the number of light emitting elements used.

The light source may be placed close to a side surface of an illuminant surface or apart from the illuminant surface, thereby increasing design flexibility. Also, with a minute fiber end and a minute wavelength conversion materials, a kind of optics for controlling the angular distribution of white light output can be decreased. This can reduce a thickness of the display apparatus itself as compared with a conventional direct-view type backlight unit.

FIG. 3 is a partially cutaway perspective view for illustrating the entire light emitting apparatus according to the present embodiment shown in FIG. 1A.

As shown in FIG. 3, the entire illuminant surface 4A is divided into a plurality of areas, and a plurality of light sources 2 and waveguide portion 3 are provided correspondingly to the divided areas. In FIG. 3, only a plurality of areas laterally arranged in line are shown for simplicity of description.

Specifically, the light emitting apparatus 1 includes an arbitrary number of LD chips 2, 2a, . . . as a plurality of light sources.

Then, light from each laser cavity is optically guided to each area of the illuminant surface 4A.

Thus, according to the present embodiment, a new local dimming type light emitting apparatus is provided in which pure optical elements without any electrical elements are placed just below a display surface of the display, light emitting elements such as LDs can be collectively provided only in a side portion as in the light guide plate system. Further, there is no need for a large PCB, thereby significantly reducing weight and costs.

### Second Embodiment

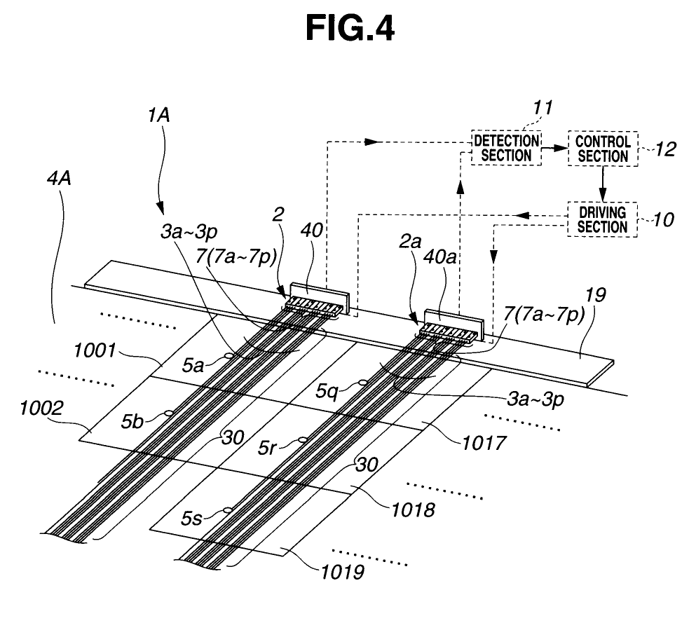

FIG. 4 is a partially cutaway perspective view of a light emitting apparatus according to a second embodiment of the present invention. In FIG. 4, the same or similar components as in the apparatus of the first embodiment are denoted by the same reference numerals and descriptions thereof are omitted, and only different components will be described.

A light emitting apparatus 1A of the second embodiment is improved to be configured as a local dimming type backlight unit (see FIG. 10) corresponding to, for example, a TV liquid crystal display having a diagonal length of 52 inches.

Specifically, as shown in FIG. 4, the light emitting apparatus 1A includes a plurality of LD chips 2 each including 16 laser cavities 7a to 7p for configuring a local dimming type backlight unit with an illuminant surface divided into 512 areas.

Specifically, 16 laser cavities 7a to 7p are provided in each of an arbitrary number of LD chips 2, 2a, . . . (hereinafter, the case of 32 LD chips arranged in a linear array on the side portion will be described by way of example in the present embodiment). Thirty-two LD chips (monolithically integrated light sources) each having the 16 laser cavities are laterally arranged in a linear array on the side portion of the backlight unit body 4 to accommodate a local dimming type backlight unit with an illuminant surface 4A divided into 32 in width×16 in length=512 areas. Specifically, the 32 LD chips are laterally arranged in a linear array on the side portion to cover all the areas of the backlight unit, and thus a backlight unit can be configured that allows the local dimming system for the entire illuminant surface.

The plurality of LD chips 2, 2a, . . . are provided on a linear PCB 19.

In the illuminant surface 4A of the backlight unit body 4, 16 areas 1001 to 1016 and 16 areas 1017 to 1032, . . . are arranged in a longitudinal direction of the backlight unit body 4 where the optical outputs from the plurality of LD chips 2, 2a, . . . are finally guided. In this case, a minute wavelength conversion member 5 is provided in each area as in the first embodiment.

The LD chips 2, 2a, . . . and the areas 1001 to 1512, that is, the 16 laser cavities 7a to 7p of the LD chips and the areas 1001 to 1512 are optically coupled by fiber arrays 30 each constituted by a plurality of fiber waveguide portions 3a to 3p.

In this case, each of the fiber waveguide portions 3a to 3p of the fiber arrays 30 can emit an output light upward with a minute wavelength conversion member (not shown), for example, in a position of each of the areas 1001, 1002, . . . , 1016 (see FIG. 1B).

Thirty two sets of the LD chips 2, 2a, . . . and the fiber arrays 30 are laterally arranged in parallel in the backlight unit body 4, and thus can transmit light to 32 in length×16 in width=512 areas 1001 to 1512. The light emitting apparatus 1A is independently driven and modulated to realize a local dimming operation.

Thus, in the light emitting apparatus 1A of the present embodiment, there is no light emitting element such as an LED just below the illuminant surface 4A of the backlight unit body 4, and an electric system and a heat radiation system can be all housed in an outer peripheral portion or the like of the backlight unit body 4.

Although a width of each of the LD chips 2, 2a, . . . is a little larger than that in the first embodiment because of a larger number of laser cavities, only 32 LD chips 2, 2a, . . . are provided on the linear PCB 19. As a result, usage of a small number of LD chips are significantly reducing costs as compared with the backlight unit 1000 that allows a direct-view type local dimming operation shown in FIG. 10.

Further, the light emitting apparatus 1A of the present embodiment can house the plurality of light emitting elements in the outer peripheral portion, and the number of light emitting elements used can be reduced. As in the first embodiment, there is no need for a large PCB under the illuminant surface, and the apparatus can be configured simply by placing the optical elements immediately below the illuminant surface 4A, thereby significantly reducing a thickness of the backlight unit, and thus reducing a thickness of a display apparatus in which the backlight unit is mounted.

In the present embodiment, the light emitting apparatus 1A may be configured to include, as shown in FIG. 4, a driving section 10 configured to drive the LD chips 2, 2a, . . . , a detection section 11 as a light detection section configured to detect a light output of the laser cavities 7a to 7p of the LD chips 2, 2a, . . . , respectively, and a control section 12 configured to control the driving section 10 by feedback of the result monitoring a part of the light output of the LD chip 2, 2a . . . at the detection section 11 to adjust a current passing through the LD chips 2, 2a, . . . and control a light output of the LD chip 2, 2a, . . . .

In this case, the monitored result of the detection section 11 is sent to the control section 12, then a control signal is fed-back to the driving section 10, thereby allowing adjustment and control of temporal and temperature variations in the light output characteristics due to, for example, degradation of the light emitting elements.

As a specific configuration, photodiodes 40, 40a, . . . as light detection sections are provided behind the LD chips 2, 2a, . . . , and can cover detecting and monitoring outputs of all of the 16 laser cavities 7a to 7p.

When an output of only one laser cavity is detected and monitored in each of the LD chips 2, 2a, . . . , the control section 12 controls to instantaneously turn off the other laser cavities. The laser element has a response speed much faster than human eyes, and thus an output of each of the 16 laser cavities 7a to 7p can be detected and monitored in timing between modulations of image signals.

One photodiode 40 can sequentially detect and monitor the outputs of each 16 laser cavities 7a to 7p, and thus only 32 photodiodes 40 may be provided, which is much lower in cost than usage of 16×32=521 photodiodes.

With the above-described configuration, the light emitting apparatus 1A of the present embodiment can realize dynamic operation on the illuminant surface by lighting sequentially the laser cavities one by one from 7a to 7p of the LD chips 2, 2a, . . . . As a result, the areas 1001 to 1016 are longitudinally lit one by one in a scanning manner in the same lateral row. The control section 12 (see FIG. 1A) controls such a dynamic operation.

In this case, the laser cavities 7a to 7p of the LD chips 2, 2a, . . . are operated one by one, thereby significantly reducing an amount of heat generation as compared with a case where all the 16 laser cavities 7a to 7p are operated. Also, the light emitting apparatus 1A of the present embodiment can perform various modulations such as black insertion.

Thus, according to the second embodiment, the same advantages as the first embodiment can be obtained, and also the light emitting apparatus 1A can be configured as a local dimming type backlight unit having an illuminant surface constituted by many divided areas, for example, 512 areas with a simple configuration and at low costs.

In the present embodiment, to configure the light emitting apparatus 1A as a local dimming type backlight unit with 512 divided areas by way of example, the number or size of LD chips, the number of laser cavities, the number of divided areas, and the form or number of the minute wavelength conversion members are specifically described, but the present invention is not limited to the specific forms, and the numbers may be set according to a required number of areas.

### Third Embodiment

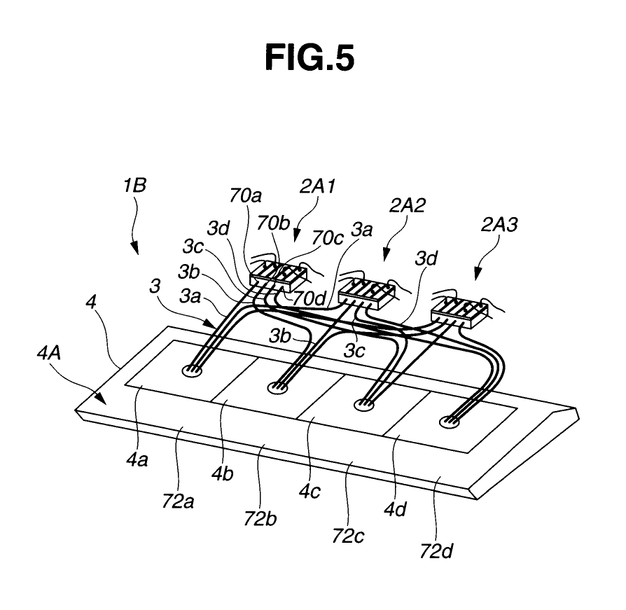

FIG. 5 is a partially cutaway perspective view of a light emitting apparatus according to a third embodiment of the present invention. In this embodiment, the same or similar components as in the apparatus of the first embodiment are denoted by the same reference numerals and descriptions thereof are omitted, and only different components will be described.

A light emitting apparatus 1B of the third embodiment is configured using RGB type LD chips 2A1, 2A2 and 2A3 without wavelength conversion of a phosphor or the like. Specifically, the LD chips 2A1, 2A2 and 2A3 each include a plurality of laser cavities 70a to 70d that lase with wavelengths of three primary colors of light: red (R), green (G) and blue (B). When the laser elements that lase at wavelengths of R, G and B, lights of R, G and B can be mixed to generate a white light, and thus in the light emitting apparatus 1B of the present embodiment, there is no need to use the minute wavelength conversion member in the first and second embodiments described above.

In the present embodiment, one LD chip includes four laser cavities 70a to 70d, but not limited to this, one LD chip may include more laser cavities.

The configuration of the LD chip 2A1 will be described. For example, in an LD chip 2A1 that emits red light, a fiber waveguide portion 3a optically coupled to the laser cavity 70a transmits light to a light emitting section 72a in an area 4a. A fiber waveguide portion 3b coupled to the laser cavity 70b transmits light to a light emitting section 72b in an area 4b. A fiber waveguide portion 3c coupled to a laser cavity 70c transmits light to a light emitting section 72c in an area 4c. A fiber waveguide portion 3d coupled to a laser cavity 70d transmits light to a light emitting section 72d in an area 4d. As such, the fiber waveguide portions 3a to 3d coupled to the laser cavities 70a to 70d distribute light to the areas 4a to 4b.

For an LD chip 2A2 that emits green light and an LD chip 2A3 that emits blue light, like the LD chip 2A1, the fiber waveguide portions 3a to 3d coupled to the laser cavities 70a to 70d distribute light to the areas 4a to 4d.

In other words, a coupled light output of the fiber waveguide portions 3a to 3d is distributed to the areas 4a to 4d so as to collect the RGB lights in one area.

Specifically, with the above-described configuration, the light emitting apparatus 1B can mix the RGB color outputs according to RGB image signals in the areas 4a to 4d, thereby allowing a color local dimming operation.

Thus, according to the third embodiment, the same advantages as the first embodiment can be obtained, and a color local dimming type light emitting apparatus 1B using LD chips can be realized without requiring a vast number of LED chips and without providing a large-size PCB as in the conventional direct-view type color local dimming system.

In the present embodiment, three LD chips 2A1, 2A2 and 2A3, four laser cavities 70a to 70d, and four areas 4a to 4d are provided, but not limited to this, and the numbers thereof may be increased as required as shown in FIG. 3.

The light emitting apparatus of the present embodiment used as a backlight unit is described by way of example, but the light emitting apparatus may be used as a display apparatus itself without a liquid crystal module or the like, and in that case, a drive signal according to an image signal or the like is supplied to each light emitting element.

### Fourth Embodiment

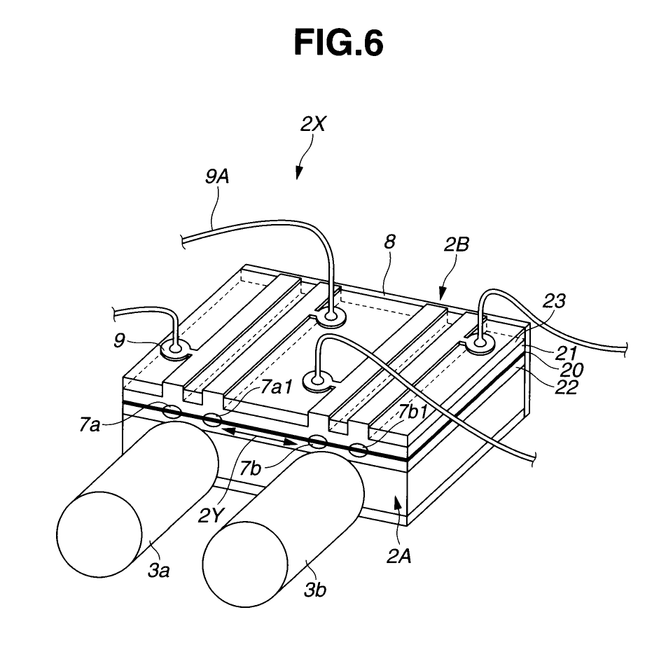

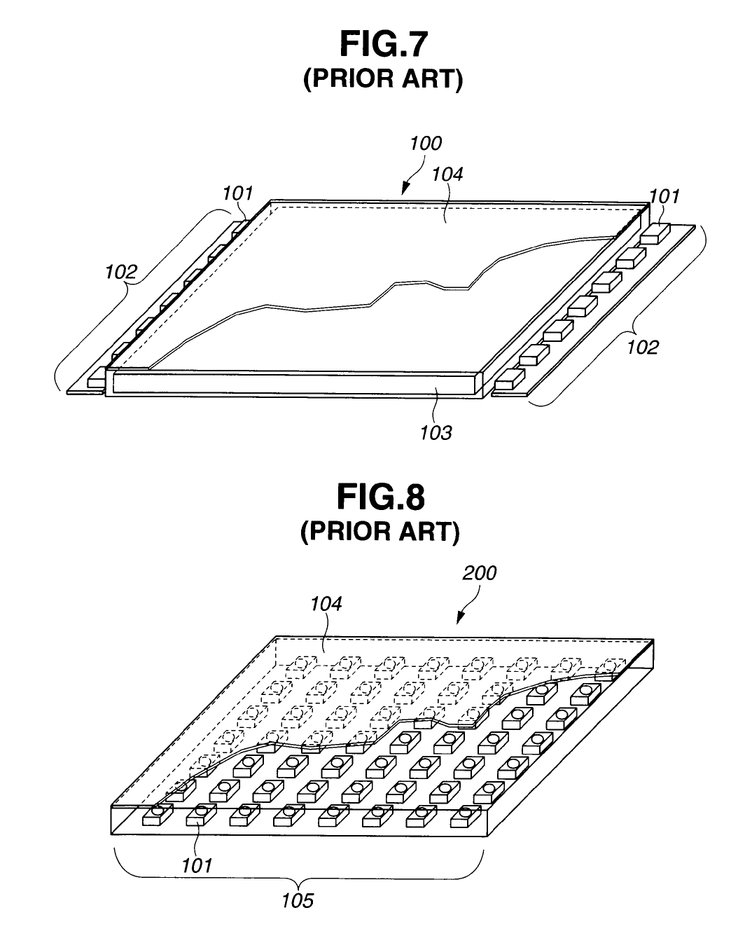

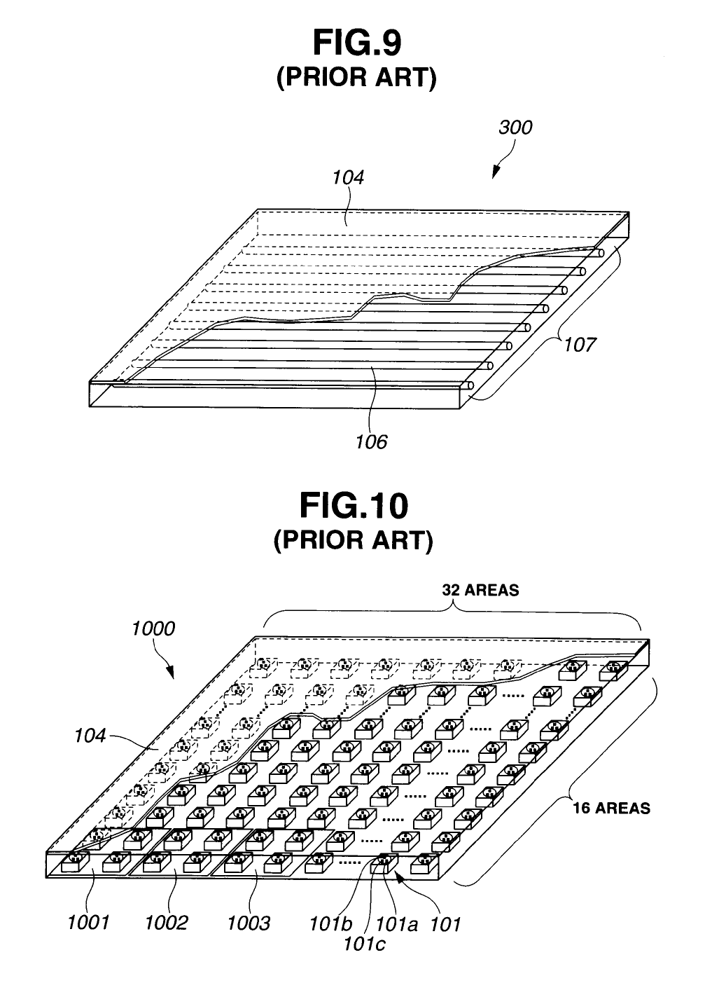

FIG. 6 is a perspective view showing an LD chip of a light emitting apparatus according to a fourth embodiment of the present invention. In the present embodiment, the same or similar components as in the apparatus of the first embodiment are denoted by the same reference numerals and descriptions thereof are omitted, and only different components will be described.

In a light emitting apparatus 1 of the fourth embodiment, an LD chip 2X as a light source is configured so that at least one of a plurality of laser cavities 7a, 7a1, 7b and 7b1 is used as a backup in failure or a booster in need of particularly high brightness.

As shown in FIG. 6, one end of each of two fiber waveguide portions 3a and 3b is optically coupled to the LD chip 2X.

The LD chip 2X includes four laser cavities 7a, 7a1, 7b and 7b1, and two laser cavities among them, for example, the laser cavity 7a and the laser cavity 7a1, and the laser cavity 7b and the laser cavity 7b1 are each arranged close to each other with an interval of 20 μm to couple outputs from the two laser cavities to one fiber easily. The other interval, that is, an interval 2Y between the laser cavity 7a1 and the laser cavity 7b is 100 μm.

With such a configuration, a light output of the two laser cavities 7a and 7a1, and a light output of the laser cavities 7b and 7b1 can be coupled to common fiber waveguide portions 3a and 3b, respectively.

The laser element itself has life and a failure mode due to ESD (electrostatic discharge) or the like. However, in the light emitting apparatus 1 using the LD chip 2X of the present embodiment, the laser cavities 7a1 and 7b1 can be used as backups, which are not used in a normal operation.

When the light emitting apparatus 1 is configured as a backlight unit of a display apparatus, it is sometimes desired to enhance brightness according to places depending on input images. In such a case, the light emitting apparatus 1 can be used as a brightness booster in the present embodiment.

In the present embodiment, the two laser cavities 7a1 and 7b1 are configured close to the other laser cavities 7a and 7b, but the laser cavities may be configured further closer to each other to increase the number of laser cavities. In this case, the laser cavities can be configured closer to each other to increase the number of laser cavities by simply changing a mask pattern in the LD chip 2X, and the footprint of the LD chip 2X does not increase, which does not increase costs of the LD chip.

Thus, according to the fourth embodiment, the same advantage as the first embodiment can be obtained, and also, at least one of the plurality of laser cavities 7a, 7a1, 7b and 7b1 of the LD chip 2X can be used as a backup in failure or a booster in need of particularly high brightness, thereby realizing a light emitting apparatus with high functionality.

In the first to fourth embodiments of the present invention, the light emitting apparatus configured as a backlight unit capable of local dimming operation used in a liquid crystal display or as the display apparatus is described as in the above, but not limited to this, the light emitting apparatus may be applied as other surface illumination apparatuses without departing from the gist of the invention. Specifically, the light emitting apparatus of the embodiments may be configured as a display apparatus or applied as a surface illumination apparatus rather than applied to the backlight unit of the liquid crystal display.

According to the above-described present embodiments, a local dimming operation can be realized using a small number of light emitting elements without using a conventional large-size PCB, thereby significantly reducing weight and costs.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A light emitting apparatus having an illuminant surface and configured to be able to adjust brightness or chromaticity for each of plural divided areas on the illuminant surface, comprising:
an integrated light source which monolithically integrates a plurality of light emitting elements which can be independently driven; and
a plurality of optical transmission lines configured to distribute a light output of each light emitting element of the integrated light source to each of the divided areas.

2. The light emitting apparatus according to claim 1, further comprising a wavelength conversion member at an output end to each of the divided areas, of the plurality of optical transmission lines configured to distribute the light output of each light emitting element of the integrated light source corresponding to each of the areas.

3. The light emitting apparatus according to claim 1, wherein the light emitting element is a semiconductor laser cavity.

4. The light emitting apparatus according to claim 1, wherein the light emitting element is an edge emission type LED.

5. The light emitting apparatus according to claim 1, wherein the illuminant surface is formed into a plane, and the integrated light source is placed in a position close to a side surface of the illuminant surface, or a position spaced apart from the illuminant surface.

6. The light emitting apparatus according to claim 1, wherein two or more light emitting elements are coupled to each of the optical transmission lines, and at least one of the plurality of light emitting elements of the integrated light source coupled to each of the optical transmission lines is used as a backup in failure or a booster in need of particularly high brightness.

7. The light emitting apparatus according to claim 1, further comprising at least one light detection section configured to detect the light output of the plurality of light emitting elements, and a control section configured to adjust a current passing through the light emitting elements based on the result detected by the light detection section and control the light output of the light emitting elements.

8. The light emitting apparatus according to claim 1, wherein each of the plurality of light emitting elements of the integrated light source includes laser cavities having wavelengths corresponding to at least three primary colors of light and configured to be independently modulated, and outputs of the three primary colors of the laser cavities are transmitted to the areas to provide mixed color of light.

9. A display apparatus configured to display an image based on an input image signal, comprising:
the light emitting apparatus according to claim 1 as a backlight unit,
and wherein brightness of light is adjusted for each of the areas according to the input image signal.

10. A display apparatus configured to display an image based on an input image signal, comprising:
the light emitting apparatus according to claim 8, and
a control section configured to independently control a laser cavity of each color for each of the areas in response to the image signal.
